(19) United States
(12) Patent Application Publication
(10) Pub. No.: US 2015/0377209 A1
(43) Pub. Date: Dec. 31, 2015

(54) HYDRAULIC ROTARY APPARATUS

(71) Applicant: KAWASAKI JUKOGYO KABUSHIKI KAISHA, Kobe-shi, Hyogo (JP)

(72) Inventors: Hideki TAMASHIMA, Himeji-shi (JP); Ryo NOMURA, Kobe-shi (JP)

(21) Appl. No.: 14/767,367

(22) PCT Filed: Apr. 30, 2014
(86) PCT No.: PCT/JP2014/061949

§ 371 Date: Aug. 12, 2015

(30) Foreign Application Priority Data
May 7, 2013 (JP) 2013-097666

(51) Int. Cl. F03C 1/06; F04B 1/20

(52) U.S. Cl. CPC F03C 1/0668; F03C 1/0663; F04B 1/2064

(57) ABSTRACT

A gap between an outer peripheral surface of a cylinder block and an inner periphery surface of a housing serves to reduce an agitation resistance of an operating oil with a simple arrangement. So this reduces an agitation loss and improves or increases a conversion efficiency between a hydraulic energy and a rotational energy.

### TECHNICAL FIELD

The present invention relates to a hydraulic rotary apparatus such as a hydraulic oil pump and a hydraulic oil motor to be used, for example, in a construction machinery and an industrial machinery.

### BACKGROUND ART

Conventionally, there has been a hydraulic oil pump as an example of a hydraulic rotary apparatus described in JP H10-9119 A (Patent Document 1). The hydraulic oil pump includes a housing, a drive shaft, a cylinder block which is fixed to the drive shaft, a plurality of cylinder pistons which are fitted in the cylinder block, and a swash plate which supports the cylinder pistons.

A protrusion is provided on an inner peripheral surface of the housing to extend axially along substantially the entire length of the cylinder block toward an inlet port of the cylinder block, allowing the operating oil in the housing to be well guided by the protrusion toward the inlet port of the cylinder block according to the rotation of the cylinder block.

### PRIOR ART DOCUMENT

### Patent Document

Patent Document 1: JP H10-9119 A

### SUMMARY OF THE INVENTION

### Problems to be Solved by the Invention

Typically, losses in the conventional hydraulic pump may be classified into a volume loss due to leakage of the operating oil and a mechanical loss caused in power transmission, which reduce a conversion efficiency in the pump from the hydraulic energy to the rotational energy and vice versa.

The volume loss varies with a load on the pump, or a pressure in the pump, namely, it increases with the pressure. The mechanical loss, as shown in FIG. 5, is substantially constant independently of the load, however, it may be critical in the idling of the pump. A substantially half of the mechanical loss consists of an agitation loss, which may not have been well known to the art.

Then, an improvement of the conversion efficiency has been primarily addressed to reduce the volume loss and a frictional element of the mechanical loss, and there has been hardly any technological progress in reducing the agitation loss. For example, in the conventional hydraulic pump the rotating cylinder block agitates the operating oil within the housing to move it in the rotational direction of the cylinder block. The movement of the oil in turn collides with the axially extending protrusions to increase the agitation resistance of the operating oil.

The increased agitation loss prevents the improvement of the conversion efficiency between the hydraulic and rotation energies, in particular, during a low pressure operation or idling operation which may be often used in the construction machinery such as a power shovel.

The reduction of the volume loss may be considered to cover a major part or approximately 95% of possible improvement in energy conversion, which means that no further improvement can be attained without any reduction of the agitation loss.

Accordingly, an object of the present invention is to provide a hydraulic rotary apparatus which is capable of improving the conversion efficiency by reducing the agitation loss.

### Solutions to the Problems

In order to accomplish the above object, there is provided, A hydraulic rotary apparatus comprising:

a housing;

a drive shaft which is mounted to the housing for rotation about a longitudinal axis of the drive shaft;

a cylinder block which is fixed to the drive shaft and has a plurality of cylinder bores defined therein and positioned around the drive shaft;

a plurality of cylinder pistons which are fitted in the cylinder bores to move in opposite directions along and within the cylinder bores;

a swash plate which has a surface, the surface being capable of being tilted relative to the longitudinal axis of the drive shaft and supporting the cylinder pistons; and

an agitation resistance reduction means for reducing an agitation resistance of liquid filled in between the housing and the cylinder block and agitated by rotations of the cylinder block.

According to the hydraulic rotary apparatus, the agitation resistance reduction means reduces the agitation resistance of liquid filled in between the housing and the cylinder block and agitated by rotations of the cylinder block. So the agitation resistance reducing means reduces the agitation loss and thereby improves or increases the conversion efficiency between the hydraulic energy and the rotational energy, in particular, in the frequently used low pressure or idling regions of the construction machinery such as power shovel.

In an embodiment of a hydraulic rotary apparatus,
the agitation resistance reduction means includes
an outer peripheral surface of the cylinder block; and
an inner peripheral surface of the housing, the outer and inner peripheral surfaces defining a gap which is configured to reduce the agitation resistance of the liquid.

According to the embodiment, the gap between the outer peripheral surface of the cylinder block and the inner periphery surface of the housing serves to reduce the agitation resistance of the liquid with a simple arrangement.

In an embodiment of a hydraulic rotary apparatus,
the agitation resistance reduction means includes:
an outer peripheral surface of the cylinder block which has a cross-section substantially perfect circular configuration; and
an inner peripheral surface of the housing which has a cross-section substantially perfect circular configuration.

Herein, a radius of the substantially perfect circle may vary from 95 percent to 105 percent of a radius of a perfect circle.

According to the embodiment, the substantially perfect circular inner and outer peripheral surfaces result in a smooth flow of the liquid at the rotation of the cylinder block to reduce the agitation resistance of the liquid with a simple structure.

In an embodiment of a hydraulic rotary apparatus,
the agitation resistance reduction means includes
a cylindrical sleeve which is arranged between an outer peripheral surface of the cylinder block and an inner peripheral surface of the housing.

According to the embodiment, the cylindrical sleeve is arranged between the outer peripheral surface of the cylinder block and the inner peripheral surface of the housing. For example, when a space communicating with a tilting control mechanism which control a tilting angle of a swash plate is formed in the housing, the cylindrical sleeve separates the space from the outer peripheral surface of the cylinder block. This results in that the flow of liquid caused by the rotation of the cylinder block is less affected by the flow of liquid in the space, which in turn decreases the agitation loss. Also, independently of the configuration of the inner peripheral surface of the housing, the agitation loss can be reduced by the existence of the cylindrical sleeve.

In an embodiment of a hydraulic rotary apparatus,
the agitation resistance reduction means includes a flow guide which is positioned on at least one of an outer peripheral surface of the cylinder block and an inner peripheral surface of the housing and extends along a peripheral direction of the cylinder block.

According to the embodiment, the flow guide is positioned on at least one of an outer peripheral surface of the cylinder block and an inner peripheral surface of the housing and extends along a peripheral direction of the cylinder block. Thus, the flow guide forcedly directs the flow of the liquid due to the rotation of the cylinder block substantially in the peripheral direction of the cylinder block to prevent an occurrence of disturbance in the flow of liquid.

### Effects of the Invention

According to the hydraulic rotary apparatus of the invention, the agitation resistance reduction means reduces the agitation resistance of liquid filled in between the housing and the cylinder block and agitated by rotations of the cylinder block, reducing the agitation loss, improving or increasing the conversion efficiency between the hydraulic energy and the rotational energy.

### BRIEF DESCRIPTION OF THE DRAWINGS

FIG. 1 is a cross-sectional view showing a hydraulic oil motor as a first embodiment of the hydraulic rotary apparatus according to the invention.

FIG. 2 is a cross-sectional view of a housing and a cylinder block.

FIG. 3 is a cross-sectional view showing a hydraulic oil motor as a second embodiment of the hydraulic rotary apparatus according to the invention.

FIG. 4 is a cross-sectional view showing a hydraulic oil motor as a third embodiment of the hydraulic rotary apparatus according to the invention.

FIG. 5 is a diagram explaining a mechanical loss.

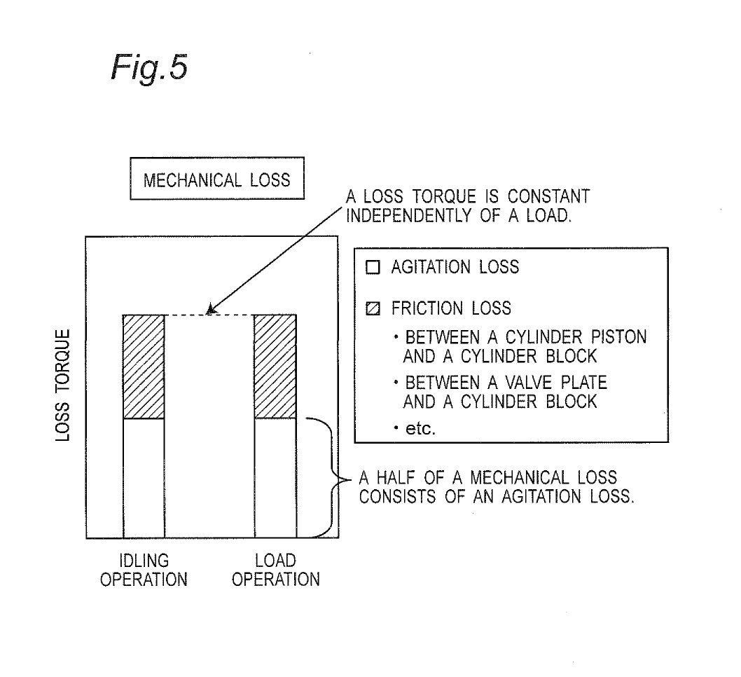

### EMBODIMENTS OF THE INVENTION

Hereinafter, this invention will be described in detail by way of embodiments thereof shown in the accompanying drawings.

### First Embodiment

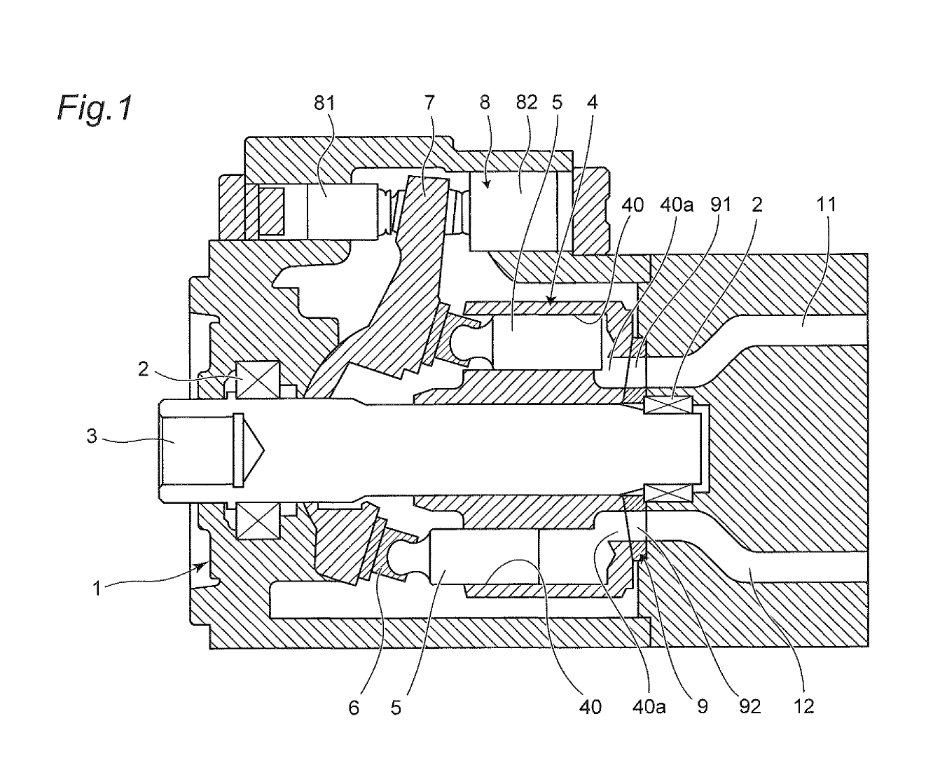

FIG. 1 is a cross-sectional view showing a hydraulic oil motor as an example of the hydraulic rotary apparatus according to the invention. As shown in FIG. 1, the motor includes a housing 1, a bearing 2 mounted in the housing, a drive shaft 3 mounted for rotation by the bearing 2, and a cylinder block 4 fixed on the drive shaft 3.

The cylinder block 4 has a plurality of cylinder bores 40 defined therein and arranged therearound in a peripheral direction. A plurality of cylinder pistons 5 are each fitted in the cylinder bores 40 so that they reciprocally move thereinside in the axial directions of the bores.

The cylinder pistons 5 have respective spherical distal end portions formed therewith, which are connected and seated in associated shoes 6. The shoes 6 are supported by a swash plate 7 positioned relative to the housing 1. The swash plate 7 has a surface which is capable of being tilted relative to the drive shaft 3, on which the cylinder pistons 5 are supported.

The swash plate 7 is configured so that its tilting angle relative to the drive axis 3 is controlled by a tilting control mechanism 8. The tilting control mechanism 8 has a first tilting piston 81 and a second tilting piston 82 which are positioned on and connected to the opposite sides of the swash plate 7.

The housing 1 has first and second major passages 11 and 12 which are configured to be liquidly communicated with selected cylinder bores 40, allowing the operating oil to flow into and out of the selected cylinder bores 40.

A valve plate 9 is mounted on an inner surface of the housing 1 to oppose an end surface of the cylinder block 4. The valve plate 9 has first and second arcuate ports 91 and 92 formed therewith symmetrically.

The cylinder block 4 has a plurality of ports 40a defined at and adjacent the bottom portions of the cylinder bores 40a for guiding the operating oil flowing in and out of the cylinder bores 40. The end surface of the cylinder block 4 is in contact with the valve plate 9.

This arrangement allows that the first major passage 11 of the housing 1 is brought into liquid communication with the port 40a of the selected cylinder bore 40 through the first port 91 of the valve plate 9 and the second major passage 12 of the housing 1 is brought into liquid communication with the port 40a of another selected cylinder bore 40 through the second port 92 of the valve plate 9.

Then, the operating oil from the first major passage 11 flows through the first port 91 into respective cylinder bores 40 one after another, which reciprocally moves the cylinder pistons 5 to rotate the cylinder block 4 and the drive shaft 3 in one direction. The oil in the cylinder bores 40 is then discharged from the second major passage 12 through the second port 92. Of course, the oil pressure in the first major passage 11 on the upstream side is greater than that in the second major passage 12 on the downstream side.

Conversely, supplying the operating oil from the second major passage 12 allows the cylinder block 4 and the drive shaft 3 to rotate in the opposite direction. In this instance, the operating oil in the cylinder bores 40 is discharged from the first major passage 11.

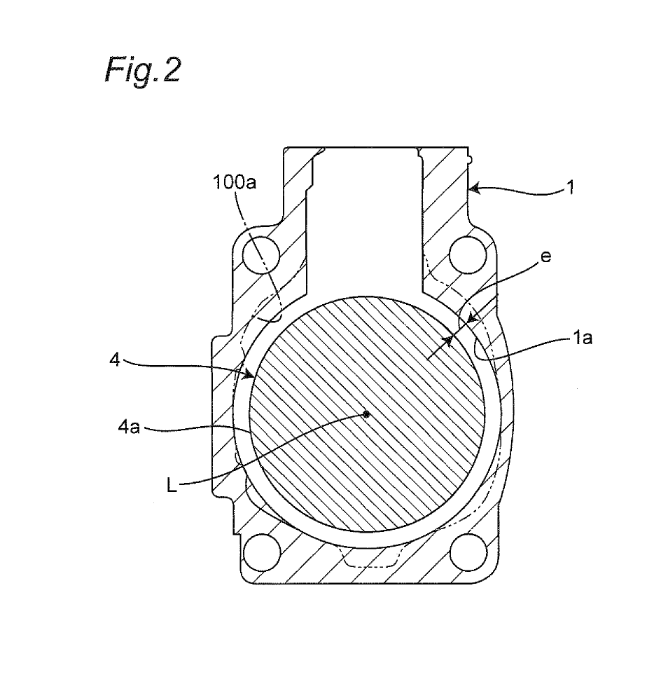

FIG. 2 is a schematic cross-sectional view of the housing 1 and the cylinder block 4 taken along line orthogonal to the longitudinal axis L of the cylinder block 4. As shown in FIG. 2, there exists a predetermined amount of gap e between an outer peripheral surface 4a of the cylinder block 4 and an inner peripheral surface 1a of the housing 1.

The amount of the gap is determined to reduce an agitation resistance which would be caused otherwise by the rotational flow or the agitation movement of the operating oil filled within the housing 1 in the rotational direction of the cylinder block 4 according to the rotation of the cylinder block 4. This means that the outer peripheral surface 4a of the cylinder block 4 and the inner peripheral surface 1a of the housing 1, defining the predetermined gap therebetween, act as an agitation resistance reducing means for reducing the agitation resistance caused between the housing 1 and the cylinder block 4 by the rotation of the cylinder block.

For example, the predetermined gap may be 5-25 percent of the radius of the cylinder block 4, which prevents an excessive enlargement of the housing 1 while keeping the agitation resistance as small as possible. Contrarily, less than 5 percent may result in a smaller gap which disadvantageously increases the agitation resistance of the operating oil and more than 25 percent may result in an excessive enlargement in the diameter of the inner periphery surface 1a of the housing 1.

The inner peripheral surface 1a of the housing 1 corresponds to the outer peripheral surface 4a of the cylinder block 4, and they have substantially perfect circular configuration. A radius of the circles may vary from 95 percent to 105 percent of a radius of a perfect circle. The substantially perfect circular inner and outer peripheral surfaces 1a and 4a serve as the agitation resistance reducing means.

According to the hydraulic motor constructed above, the agitation resistance reducing means reduces the agitation loss and thereby improves or increases the conversion efficiency between the hydraulic energy and the rotational energy, in particular, in the frequently used low pressure or idling regions of the construction machinery such as power shovel.

The gap e between the outer peripheral surface 4a of the cylinder block 4 and the inner periphery surface 1a of the housing 1 serves to reduce the agitation resistance of the operating oil with a simple arrangement.

The substantially perfect circular inner and outer peripheral surfaces 1a and 4a result in a smooth flow of the operating oil at the rotation of the cylinder block 4 to reduce the agitation loss of the operating oil with a simple structure.

As shown in FIG. 2, an inner peripheral surface 100 of the conventional housing has convex or thick portions for increasing the mechanical strength of the housing and concave or thin portions for decreasing the weight of the housing, which does not lead to an arrangement wherein a certain amount of gap is formed between the inner peripheral surface of the housing and the outer peripheral surface of the cylinder block and the inner and outer surfaces take respective substantially perfect circular configurations.

### Second Embodiment

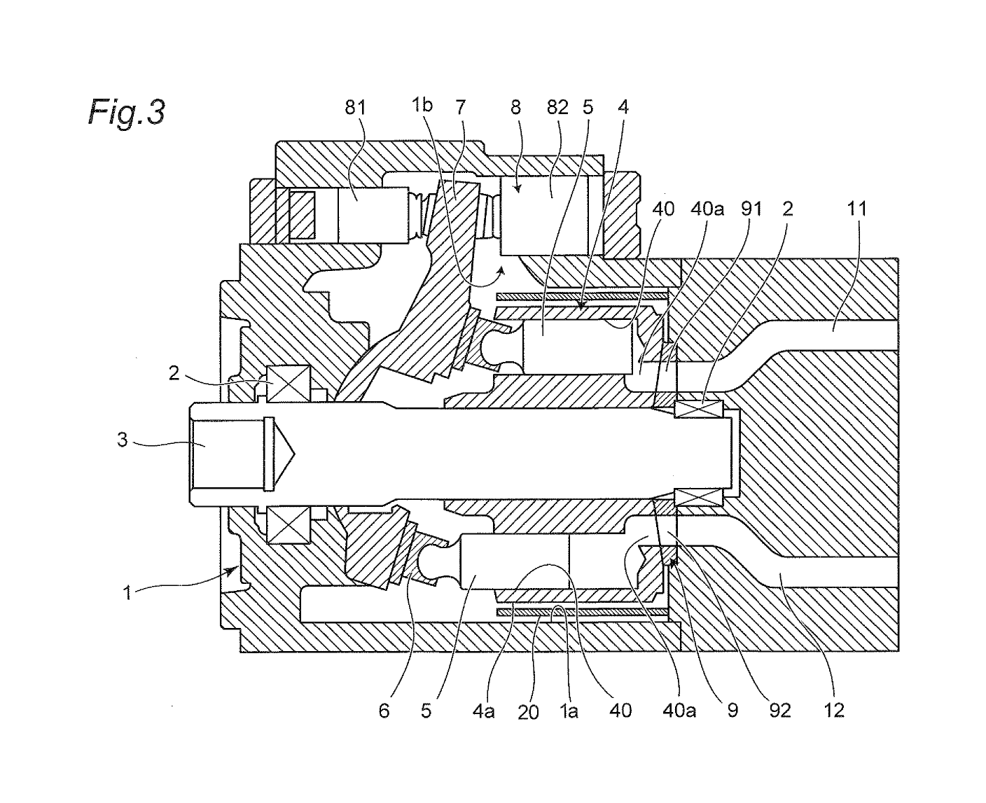

FIG. 3 is a cross-sectional view showing a second embodiment of the hydraulic oil motor according to the invention. The second embodiment differs from the first embodiment in terms of the construction of the agitation resistance reduction means. In the second embodiment, like reference signs designate like members in conjunction with the first embodiment and duplicate descriptions will be omitted.

As shown in FIG. 3, a cylindrical sleeve 20 is arranged between the outer peripheral surface 4a of the cylinder block 4 and the inner peripheral surface 1a of the housing 1, which is an exemplary embodiment of the agitation resistance reduction means.

The cylindrical sleeve 20, which is fixed to the housing 1, has a substantially perfect circular configuration which extends along the outer peripheral surface 4a of the cylinder block 4. A radius of the circles may vary from 95 percent to 105 percent of a radius of a perfect circle.

The cylindrical sleeve 20 separates a space 1b accommodating the tilting control mechanism 8 and adjacent the inner peripheral surface 1a of the housing 1 from the outer peripheral surface 4a of the cylinder block 4. This results in that the flow of operating oil caused by the rotation of the cylinder block 4 is less affected by the flow of operating oil in the space 1b, which in turn decreases the agitation loss. Also the inner peripheral surface 1a of the housing 1 may have convex and/or concave portions. Even in this case, the agitation loss can be reduced by the existence of the cylindrical sleeve 20.

### Third Embodiment

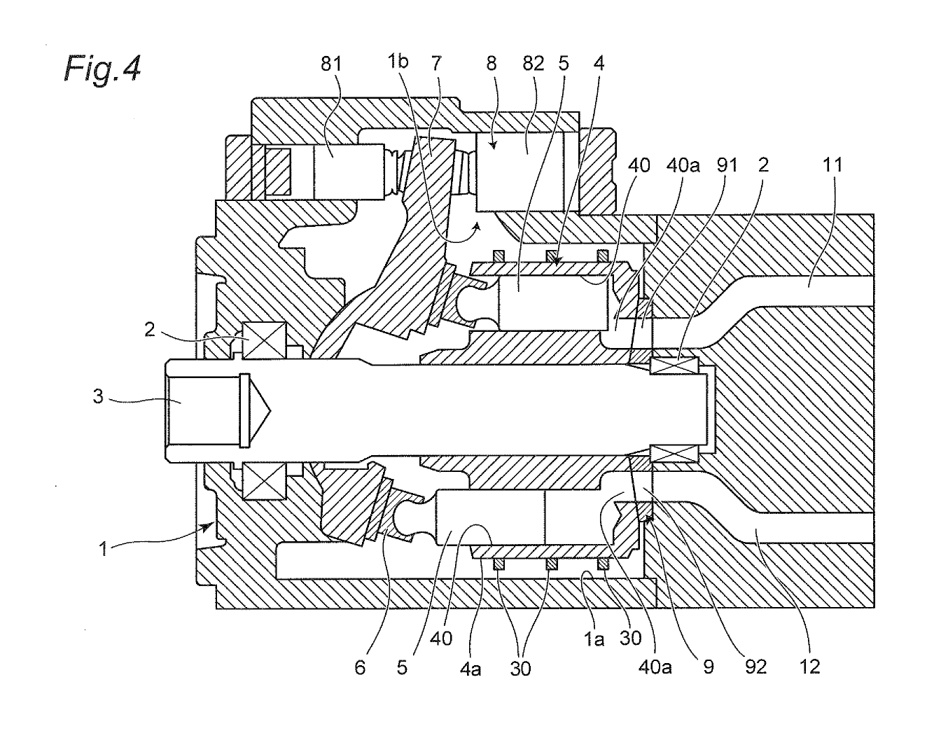

FIG. 4 is a cross-sectional view showing a third embodiment of the hydraulic oil motor according to the invention. The third embodiment differs from the first embodiment in terms of the construction of the agitation resistance reduction means. In the third embodiment, like reference signs designate like members in conjunction with the first embodiment and duplicate descriptions will be omitted.

As shown in FIG. 4, a plurality of, i.e., three in this embodiment, flow guides 30 are provided on the outer peripheral surface 4a of the cylinder block 4, which serve as a agitation resistance reduction means.

The flow guides 30 extend in the peripheral direction of the cylinder block 4 and are spaced apart from each other in the axial direction of the cylinder block 4.

Thus, the flow guides 30 forcedly direct the flow of the operating oil due to the rotation of the cylinder block 4 substantially in the peripheral direction of the cylinder block 4 to prevent an occurrence of disturbance in the flow of operating oil.

The present invention is not limited to the aforementioned embodiments. For example, respective features of the first to the third embodiments may be combined in various ways. For example, two or more of agitation resistance reduction means of the first to the third embodiment may be combined in various ways.

Although the first embodiment employs a first arrangement in which a predetermined amount of gap is provided between the outer peripheral surface of the cylinder block and a second arrangement in which the inner peripheral surface of the housing and the outer peripheral surface of the cylinder block take substantially perfect circular configurations, either one of two arrangements may be employed selectively. Also, the selected arrangement may include the cylindrical sleeve of the second embodiment and/or the flow guides of the third embodiment.

Also, although in the third embodiment the flow guides are provided on the outer peripheral surface of the cylinder block, additionally or alternatively they may be provided on at least one of the outer peripheral surface of the cylinder block and the inner peripheral surface of the housing.

Further, the second embodiment may have at least one of three arrangements, i.e., first arrangement in the first embodiment in which a predetermined amount of gap is provided between the outer peripheral surface of the cylinder block, second arrangement also in the first embodiment in which in which the inner peripheral surface of the housing and the outer peripheral surface of the cylinder block take substantially perfect circular configurations, and third arrangement in the third embodiment in which the flow guide are provided.

Furthermore, the third embodiment may have at least one of three arrangements, i.e., first arrangement in the first embodiment in which a predetermined amount of gap is provided between the outer peripheral surface of the cylinder block, second arrangement also in the first embodiment in which in which the inner peripheral surface of the housing and the outer peripheral surface of the cylinder block take substantially perfect circular configurations, and fourth arrangement in the second embodiment in which the cylindrical sleeve is provided.

Although the hydraulic rotary pump according to the invention has been described in connection with the hydraulic motor, it may equally be applied to a hydraulic pump.

### DESCRIPTION OF REFERENCE SIGNS

1: Housing
1a: Inner peripheral surface
1b: Space
3: Drive shaft
4: Cylinder block
4a: Outer peripheral surface
5: Cylinder piston
7: Swash plate
8: Tilting control mechanism
9: Valve plate
20: Cylindrical sleeve
30: Flow guide
40: Cylinder bore
e: Gap

1. A hydraulic rotary apparatus, comprising:
a housing;
a drive shaft which is mounted to the housing for rotation about a longitudinal axis of the drive shaft;
a cylinder block which is fixed to the drive shaft and has a plurality of cylinder bores defined therein and positioned around the drive shaft;
a plurality of cylinder pistons which are fitted in the cylinder bores to move in opposite directions along and within the cylinder bores;
a swash plate which has a surface, the surface being capable of being tilted relative to the longitudinal axis of the drive shaft and supporting the cylinder pistons; and
an agitation resistance reduction means for reducing an agitation resistance of liquid filled in between the housing and the cylinder block and agitated by rotations of the cylinder block.

2. The hydraulic rotary apparatus according to claim 1, wherein
the agitation resistance reduction means includes
an outer peripheral surface of the cylinder block; and
an inner peripheral surface of the housing, the outer and inner peripheral surfaces defining a gap which is configured to reduce the agitation resistance of the liquid.

3. The hydraulic rotary apparatus according to claim 1, wherein
the agitation resistance reduction means includes:
an outer peripheral surface of the cylinder block which has a cross-section substantially perfect circular configuration; and
an inner peripheral surface of the housing which has a cross-section substantially perfect circular configuration.

4. The hydraulic rotary apparatus according to claim 1, wherein
the agitation resistance reduction means includes a cylindrical sleeve which is arranged between an outer peripheral surface of the cylinder block and an inner peripheral surface of the housing.

5. The hydraulic rotary apparatus according to claim 1, wherein
the agitation resistance reduction means includes a flow guide which is positioned on at least one of an outer peripheral surface of the cylinder block and an inner peripheral surface of the housing and extends along a peripheral direction of the cylinder block.
